(19) United States
(12) Patent Application Publication
(10) Pub. No.: US 2004/0098596 A1
(43) Pub. Date: May 20, 2004

(54) Driverless USB security token

(75) Inventors: Laszlo Elteto, Irvine, CA (US); Brian D. Grove, Laguna Niguel, CA (US); Mehdi Sotoodeh, Mission Viejo, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignees: Rainbow Technologies, Inc.; Rainbow Technologies, B.V.

(21) Appl. No.: 10/704,999

(22) Filed: Nov. 10, 2003

Related U.S. Application Data
(60) Provisional application No. 60/426,571, filed on Nov. 15, 2002.

(51) Int. Cl. H04K 1/00

(52) U.S. Cl. 713/185

(57) ABSTRACT

A method and apparatus for communicating information between a token and a host computer having a host computer operating system (OS) supplied inherent driver for communicating with an OS-supported USB-compliant device. The method comprising the steps of coupling to the host computer, and emulating the OS-supported USB-compliant device. In one embodiment, the step of emulating the OS-supported USB-compliant device comprises the steps of accepting a message from the OS-supplied inherent driver in the token, the message transmitted according to a format and protocol for the OS-supported USB-compliant device; generating a second message from the accepted first message; and providing a second message from the token to the OS-supplied inherent driver.

### CROSS-REFERENCE TO RELATED APPLICATIONS

This application claims benefit of U.S. Provisional Patent Application No. 60/426,571, entitled “DRIVERLESS USB SECURITY TOKEN,” by Laszlo Elteto, Brian D. Grove, and Mehdi Sotoodeh, filed Nov. 15, 2002 which application is hereby incorporated by reference herein.

This application is related to the following co-pending and commonly assigned patent application(s), all of which applications are incorporated by reference herein:

Application Ser. No. 10/289,042, entitled “TOKEN FOR STORING INSTALLATION SOFTWARE AND DRIVERS” filed Nov. 6, 2002, by Laszlo Elteto; and

Application Ser. No. 09/449,159, filed Nov. 24, 1999, by Shawn D. Abbott, Bahram Afghani, Mehdi Sotoodeh, Norman L. Denton III, and Calvin W. Long, and entitled “USB-COMPLIANT PERSONAL KEY WITH INTEGRAL INPUT AND OUTPUT DEVICES,” which is a continuation-in-part of U.S. patent application Ser. No. 09/281,017, filed Mar. 30, 1999 by Shawn D. Abbott, Bahram Afghani, Allan D. Anderson, Patrick N. Godding, Maarten G. Punt, and Mehdi Sotoodeh, and entitled “USB-COMPLIANT PERSONAL KEY,” which claims benefit of U.S. Provisional Patent Application No. 60/116,006, filed Jan. 15, 1999 by Shawn D. Abbott, Barham Afghani, Allan D. Anderson, Patrick N. Godding, Maarten G. Punt, and Mehdi Sotoodeh, and entitled “USB-COMPLIANT PERSONAL KEY”.

### BACKGROUND OF THE INVENTION

1. Field of the Invention

The present invention relates to systems and methods for communicating between a token and a host computer, and in particular to a system and method for communicating between the token and the host computer using pre-installed generic OS USB device drivers.

2. Description of the Related Art

Security tokens provide a highly-portable secure repository for the storage of security-related information, including, for example, passwords, digital certificates, public and private keys. Security tokens also provide the functionality to support the secure exchange of such information as required for user authentication and other purposes.

One factor limiting the usefulness of such tokens is that they typically require token-specific drivers that must be pre-installed on the host computer. Without such drivers, the user cannot use the token in kiosks or other computer systems shared by a plurality of users.

One solution to this problem is to simply carry driver software and install it on any computer as required. However, this solution has several serious disadvantages. First, since driver software is typically embodied on a floppy disk or a CD-ROM, it is inconvenient to carry the driver software in addition to the token itself. Second, the I/O devices that read the driver software are prone to hardware failures from repeated use (especially an issue when the host computer is shared by a large number of users). Third, this solution increases the storage requirements of the host computer, as it may be asked to store an excessive number of software drivers (one for each of the different token types). While it is possible for the host computer to simply delete installed software drivers after use, this requires the user to reinstall the driver software each time the token is used.

Drivers can also be distributed via the Internet, or even stored the driver itself on the token itself, as described in related patent application Ser. No. 0/289,042, entitled “TOKEN FOR STORING INSTALLATION SOFTWARE AND DRIVERS”. However, in some operating systems (e.g. Windows 2000 or XP), driver installation requires administrator level privileges, and most users (particularly in situations where several users may be using a single computer) cannot be granted administrator level privileges.

What is needed is a way to allow use of a USB security token without requiring the user to install a vendor-specific device driver. The present invention satisfies this need.

### SUMMARY OF THE INVENTION

To address the requirements described above, the present invention discloses a method and apparatus, for communicating information between a token and a host computer having a host computer operating system (OS) supplied inherent driver for communicating with an OS-supported USB-compliant device. The method comprising the steps of coupling to the host computer, and emulating the OS-supported USB-compliant device. In one embodiment, the step of emulating the OS-supported USB-compliant device comprises the steps of accepting a message from the OS-supplied inherent driver in the token, the message transmitted according to a format and protocol for the OS-supported USB-compliant device; generating a second message from the accepted first message; and providing a second message from the token to the OS-supplied inherent driver. The apparatus comprises a USB port for coupling to the host computer, and a processor, communicatively coupled to a memory storing instructions for emulating the OS-supported USB-compliant device.

### BRIEF DESCRIPTION OF THE DRAWINGS

Referring now to the drawings in which like reference numbers represent corresponding parts throughout:

FIG. 1 is a block diagram showing an exemplary hardware environment for practicing the present invention;

FIG. 2 is a block diagram illustrating selected modules of the present invention;

FIG. 3 is a diagram of the memory resources provided by one embodiment of the memory of the personal key; FIG. 4 is a diagram illustrating an embodiment of the file system of the token;

FIGS. 5A and 5B are diagrams presenting exemplary method steps that can be used to practice one embodiment of the present invention; and

FIGS. 6A and 6B are diagrams illustrating how an emulated file can be used to send commands and receive results from the token.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

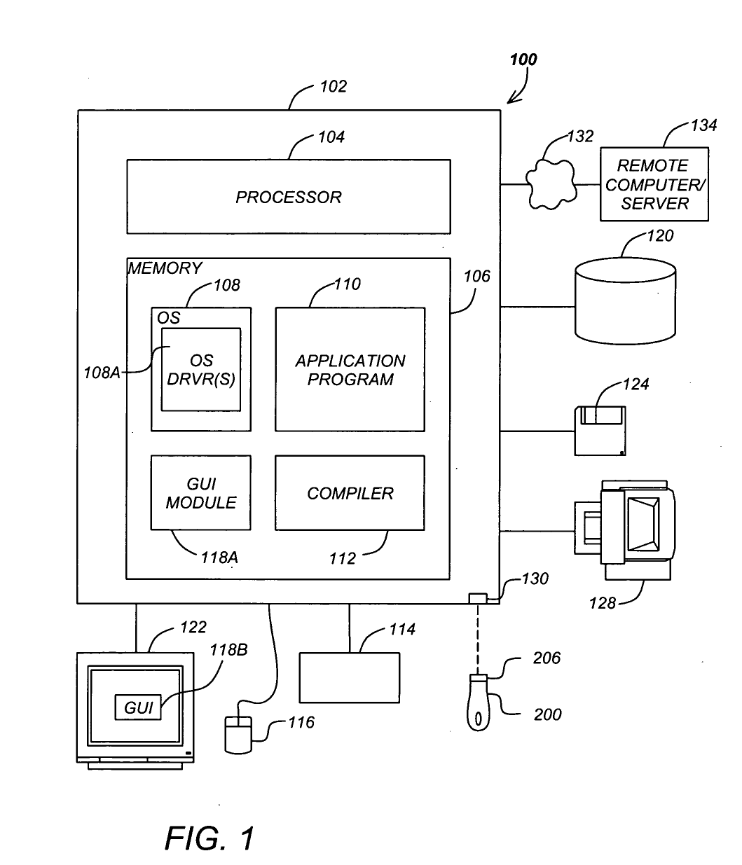

FIG. 1 illustrates an exemplary computer system 100. The computer 102 comprises a processor 104 and a memory 106, such as random access memory (RAM). The computer 102 is operatively coupled to a display 122, which presents images such as windows to the user on a graphical user interface 118B. The computer 102 may be coupled to other devices, such as a keyboard 114, a mouse device 116, a printer 128, etc. Of course, those skilled in the art will recognize that any combination of the above components, or any number of different components, peripherals, and other devices, maybe used with the computer 102.

Generally, the computer 102 operates under control of an operating system (OS) 108 stored in the memory 106, and interfaces with the user to accept inputs and commands and to present results through a graphical user interface (GUI) module 118A. The OS 108 also includes a set of inherent device drivers 108A that can be used to interface the computer 102 with a variety of I/O devices These device drivers include pre-installed device drivers for popularly available specific devices and peripherals, as well as generic drivers that provide at least a minimum functionality with a class of devices.

The inherent device drivers 108A include a generic driver for a USB-compliant device, which may include a USB hub or other USB-compliant peripheral, such as a printer, modem, mouse, keyboard, microphone, loudspeaker, or other human interface device (HID). In one embodiment, the operating systems comprises MICROSOFT Corporation's WINDOWS b 98, ME, 2000, and XP, however, the present invention can be used with host computer system which includes one or more pre-installed device drivers that are compatible with the token 200.

Although the GUI module 118A is depicted as a separate module, the instructions performing the GUI functions can be resident or distributed in the operating system 108, the computer program 110, or implemented with special purpose memory and processors. The computer 102 also implements a compiler 112 which allows an application program 110 written in a programming language such as COBOL, C++, FORTRAN, or other language to be translated into processor 104 readable code. After completion, the application 110 accesses and manipulates data stored in the memory 106 of the computer 102 using the relationships and logic that are generated using the compiler 112. The computer 102 also comprises an input/output (I/O) port 130 for a token 200 (hereinafter alternatively referred to also as a personal key, personal token, or security token 200). In one embodiment, the I/O port 130 is a USB-compliant port implementing a USB-compliant interface.

In one embodiment, instructions implementing the operating system 108, the computer program 110, and the compiler 112 are tangibly embodied in a computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of instructions which, when read and executed by the computer 102, causes the computer 102 to perform the steps necessary to implement and/or use the present invention. Computer program 110 and/or operating instructions may also be tangibly embodied in memory 106 and/or data communications devices, thereby making a computer program product or article of manufacture according to the invention. As such, the terms “article of manufacture” and “computer program product” as used herein are intended to encompass a computer program accessible from any computer readable device or media.

The computer 102 may be communicatively coupled to a remote computer or server 134 via communication medium 132 such as a dial-up network, a wide area network (WAN, local area network (LAN), virtual private network (VPN) or the Internet. Program instructions for computer operation, including additional or alternative application programs can be loaded from the remote computer/server 134. In one embodiment, the computer 102 implements an Internet browser, allowing the user to access the world wide web (WWW) and other internet resources.

Those skilled in the art will recognize that many modifications may be made to this configuration without departing from the scope of the present invention. For example, those skilled in the art will recognize that any combination of the above components, or any number of different components, peripherals, and other devices, may be used with the present invention.

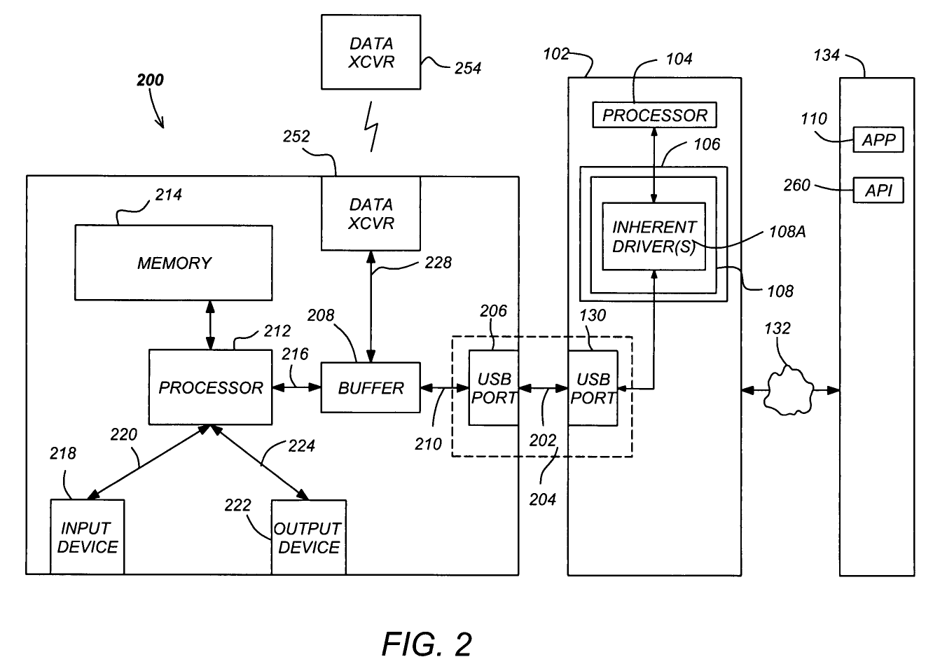

FIG. 2 is a block diagram illustrating selected modules of the present invention. The personal key 200 communicates with and obtains power from the host computer through a USB-compliant communication path 202 in the USB-compliant interface 204 which includes the input/output port 130 of the host computer 102 and a matching input/output (I/O) port 206 on the personal key 200. Mechanical, electrical, and communication interfaces between the personal key 200 and the host computer 102 are set forth in “Universal Serial Bus Specification,” Revision 1.1, published Sep. 23, 1998 by the COMPAQ, INTEL, MICROSOFT, and NEC Corporations, which is hereby incorporated by reference herein, and is available at www.usb.org.

Signals received at the personal key I/O port 206 are passed to and from the processor 212 by a driver/buffer 208 via communication paths 210 and 216. The processor 212 is communicatively coupled to a memory 214, which may store data and instructions to implement the above-described features of the invention. In one embodiment, the memory 214 is a non-volatile random-access memory that can retain factory-supplied data as well as customer-supplied application related data. The processor 212 may also include some internal memory for performing some of these functions.

The processor 212 is optionally communicatively coupled to an input device 218 via an input device communication path 220 and to an output device 222 via an output device communication path 224, both of which may be distinct from the USB-compliant interface 204 and communication path 202. These separate communication paths 220 and 224 allow the user to view information about processor 212 operations and provide input related to processor 212 operations without allowing a process or other entity with visibility to the USB-compliant interface 204 to eavesdrop or intercede. This permits secure communications between the key processor 212 and the user.

In one embodiment of the present invention, the personal key 200 also comprises a data transceiver 252 for communicating data with an external data transceiver 254. The data transceiver 252 is communicatively coupled to the processor 212, via the buffer 208 and communication paths 216 and 228, and allows the personal key 200 to transmit and receive data via the transmission and reception of electromagnetic waves (including infrared or radio frequency waves) without exposing the data to the USB-compliant interface 204. The data transceiver 252 can also be used to transmit and receive information from a similarly equipped host computer 102, thus reducing wear from repeated insertions and withdrawals of personal keys 200 in the USB port 130. This feature is especially useful where the host computer 102 is shared with a variety of users, for example, when used in a kiosk.

In one embodiment, the personal key 200 also comprises a power source such as a battery or capacitive device. The power source supplies power to the components of the personal key to allow the data to be retained and to allow personal key functions and operations to be performed, even when disconnected from the host computer 102.

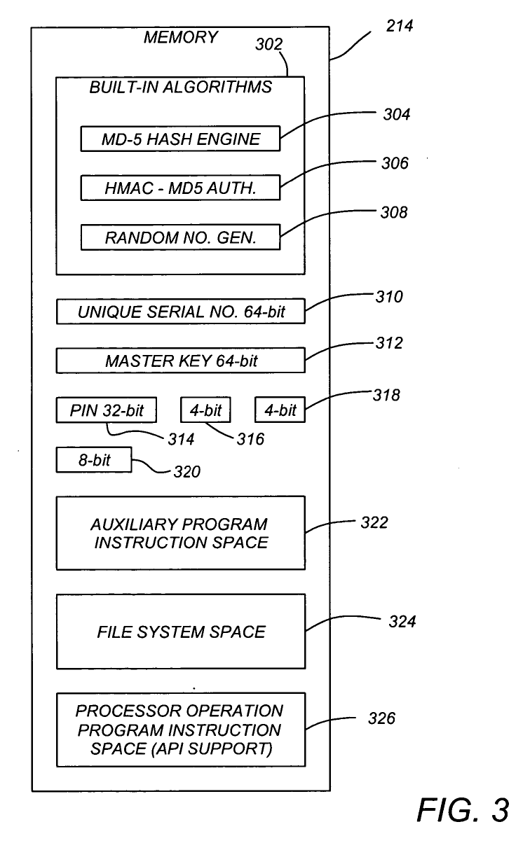

FIG. 3 is a diagram of the memory resources provided by the memory 214 of the personal key 200. The memory resources include a master key memory resource 312, a personal identification number (PIN) memory resource 314, an associated PIN counter register 316 and PIN reset register resource 318, a serial number memory resource 310, a global access control register memory resource 320, a file system space 324, auxiliary program instruction space 322, and a processor operation program instruction space 326. The processor operation program instruction space 326 stores instructions that the personal key 200 executes to perform the nominal operations described herein, including those supporting functions called by an application program interface associated with the application programs 110 executing in either the host computer 102 or the remote server 134. The auxiliary program instruction space provides the personal key 200 with space to store processor 212 instructions for implementing additional functionality, if desired.

The master key is an administrative password that must be known by the trusted entity or program that will initialize and configure the personal key 200. For example, if the personal key 200 is to be supplied to a number of remotely located employees to enable access to private documents stored in a remote server through a VPN, the system administrator for the remote server may enter the master key (or change the key from the factory settings) before providing the key to the remotely located employees. The system administrator also stores the master key in a secure place, and uses this master key to perform the required secure operations (including, for example, authorization and authentication of the remote users).

In one embodiment, the master key can not be configured, reset, or initialized if the MKEY can not be verified first. Hence, if the master key is unknown, the personal key 200 would have to be destroyed/thrown away or returned to the factory to be reset to the factory settings.

The PIN is an optional value that can be used to authenticate the user of the personal key 200. The PIN is initialized by the trusted administrator. Depending on how the personal key 200 initialization program is implemented and deployed, it is possible for the end user to set and/or update their PIN. The PIN may comprise alphanumeric characters or simply numbers. Registers 316 and 318 can be used to check the correct entry of the PIN and to prevent rogue applications or users from rapidly testing a large number of PINs in an attempt to compromise the personal key 200.

The serial number is a unique factory installed serial number (SN). The serial number can be used to differentiate a single user from all other personal key 200 users.

The memory 214 of the personal key 200 also includes built in algorithm memory resources 302, including a MD-5 hash engine memory 304 for storing related processing instructions, an HMAC-MD5 authorization memory resource 306 for storing related processing instructions, and a random number generator memory resource 308 for storing processing instructions for generating random numbers. The random number generator can be used to generate challenges to be used when generating authentication digest results as well as to provide seeds to other cryptographic procedures. The MD-5 algorithm accepts as an input a message of arbitrary length, and produces a 128-bit “fingerprint” or “message digest” of the input as an output. In doing so, the algorithm scrambles or hashes the input data into a reproducible product using a high speed algorithm such as RFC-1321. The hashed message authentication codes (HMAC) can be used in combination with any iterated cryptographic hash function (e.g. MD-5) along with a secret key, to authenticate a message or collection of data. The personal key 200 integrates this method to provide a way for the end user or application data to be authenticated without exposing the secret key.

FIG. 4 is a diagram illustrating an embodiment of a file system 400 of the token 200, illustrating the data contents of a file system memory resource 324 of an active personal key 200 that provides authentication and specific configuration data for several applications. The master file (MF) 402 is the root directory and uses an identification (ID) of zero (0). The MF 402 may contain pointers 404A and 404B or other designations to data files 406A and 406B, as well as pointers 408A and 408B to directories 410 and 416. Directories and files are defined by an identification (4 → 0xFFFFFFFF for the directories, and 0 → 0xFFFFFFFF for files). The directories 410 and 416 also contain pointers (412A-412B and 418A-418C, respectively) to data files (414A-414B and 420A-420C, respectively.

### Driverless Token Overview

Typical recent operating systems 108, such as MICROSOFT Corporation's WINDOWS 98, ME, 2000, and XP, include a plurality of inherent device drivers 108A for I/O devices and peripherals. Such I/O devices and peripherals can be found on the hardware compatibility list at www.microsoft.com).

Because such drivers 108A are included in the operating system 108 and are always installed when the computer 102 is started up (that is, they are pre-installed) and thereafter run invisibly, these drivers can be used to facilitate communications between the personal key 200 and the computer 102. Such drivers include USB controller drivers, USB Floppy Drive drivers, and USB hub drivers.

Instead of operating like existing personal tokens 200, (e.g. providing a proprietary interface to the host computer system in the form of drivers that must be installed on the host computer 100 after start-up) the present invention advantageously uses these pre-installed inherent device drivers 108A. The token 200 emulates, and thus “pretends” to be another generic USB device type, so the default installed USB drivers 108A of the host computer operating system 108 recognize the token 200 as a USB device and provide a means (e.g. software modules) for application programs 110 to communicate with it. Using this technique, any and all communication means these device drivers 108A provide or will provide in the future can be utilized to communicate with the token 200 (i.e. send commands and retrieve results). The token 200 can emulate a number of generic USB devices, including a USB hub, a mass storage device, an HID, or an audio device. Special considerations for each such device are discussed below.

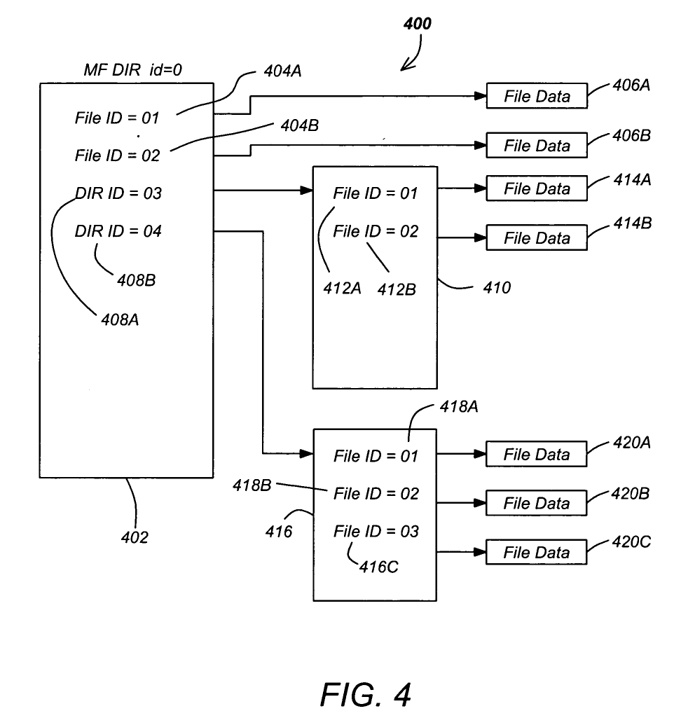

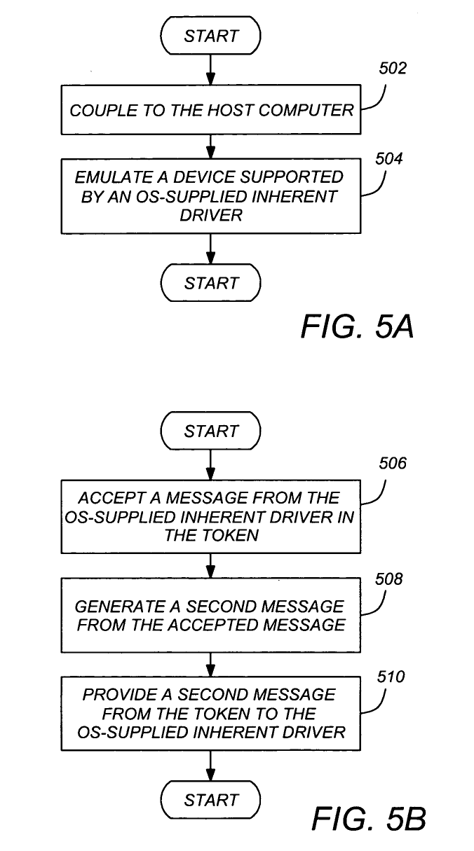

FIG. 5A is a flow chart presenting exemplary method steps that can be used to practice the present invention. A token 200 is coupled to the host computer, as shown in block 502. This is accomplished via the interaction between the I/O port of the personal key 206 and the host computer 130 achieved by insertion of the personal key 200. The token then emulates the OS-supported USB-compliant device, as shown in block 504.

FIG. 5B is a flow chart presenting exemplary method steps that can be used to emulate the OS-supported USB-compliant device. A message is accepted from the OS-supplied inherent driver 108A in the token 200. The message may comprise data and/or a command, and can be accomplished using the techniques described below. The token 200 generates a response message using the information in the message accepted in block 506. This is as shown in block 508. The token 200 then provides the second message from the token to the OS-supplied inherent driver 108A, as shown in block 510. This can be accomplished by using the token 200 to transmit the second message to the host computer 102, or by simply storing the second message in a location accessible by the driver 108A.

### Hub Emulation

In this embodiment, the token 200 “emulates” an empty hub (i.e. one USB hub with one or more empty ports). The emulation may be a full emulation (i.e. the device understands and responds to all proper USB hub commands defined in the Universal Serial Bus Specification described above). A full emulation is relatively simple to implement, as the emulation will always tell the host that there are no “devices” attached to any of the “ports” of the hub (i.e. status will always report “no device” and any other command directed to a port will just be ignored). Alternatively, the emulation may only accept and respond to only a subset of USB hub commands.

Commands and/or data can be sent to the personal token 200 in a variety of ways, with the selection of a particular technique for communicating commands or data depending upon which commands the selected inherent driver 108A supports. For example, commands can be sent by transmitting an enable/disable or a power on/off command to the “ports” of the emulated hub. The personal token 200 may then use the enable/disable or power on/off status to generate a response.

For example, to send a command, the host computer 102 can decode the command as a series of bits, with each bit being a “0” or a “1”. For a “0” bit, it sends a CLEAR_FEATURE command to the hub (e.g. C_PORT_ENABLE—i.e. disable a port); for a “1” bit it sends a SET_FEATURE command (e.g. PORT_ENABLE—i.e. enable the port). The hub's response will also be collected bit by bit: for each bit the host sends a GET_STATUS (Get Port Status) command and check for a particular bit (e.g. bit 1, port enabled/disabled) in the status response.

The host computer 102 can then retrieve a response by transmitting a port status request to the token 200 and/or by reading various USB descriptor values.

### Mass Storage Emulation

Unlike existing USB storage tokens, the present invention can use the file system 400 of the token 200 as a communications channel with the token 200. This is accomplished by writing data to and reading data from one or more emulated files or portions of the emulated files. This can be accomplished by using the memory 214 and file system 400 of the token, to “emulate” files on a mass storage device. Emulated files do not require provision of any storage in the token 200, it is enough to “emulate” only one (or more) fixed file(s). In either case, whether the data is written to and read from an actual file or an emulated file, this can be accomplished as described below.

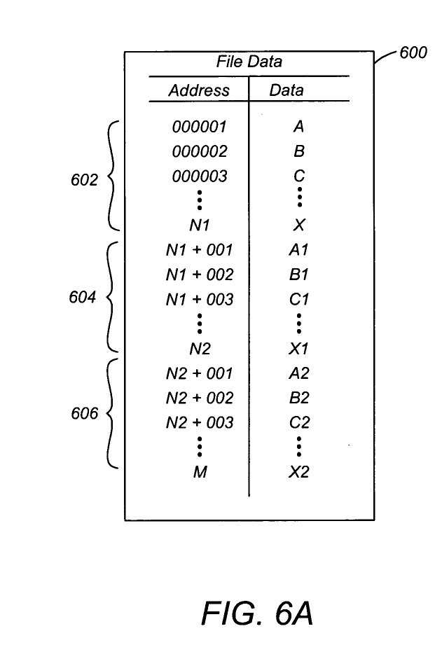

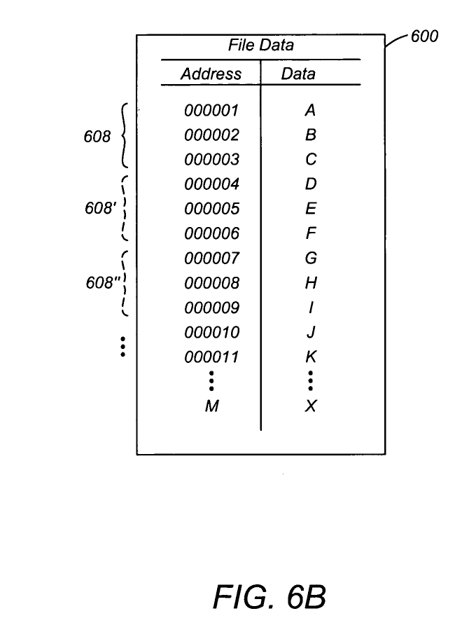

FIG. 6A is a diagram illustrating how an emulated file 600 can be used to send commands to and receive results from the token 200. To send a command to the token 200, the application program 110 running on the host computer 102 writes the command to a first area (e.g. area 602) of this file 600. The token 200 then interprets this write operation as a command, and executes the indicated command. The command type can be indicated by which of the areas 602-606 the data is written to, or one or more portions of the data A, B, C . . . X; A1, B1, C1 . . . X1; A2, B2, C2 . . . X3 itself. The token 200 writes the command result to a second 604 (or the first 602) area of the file 600. The application program 110 can then retrieve this command result by simply reading the second 604 (or the first 602) area of this file 600. This can also be accomplished by writing commands to one file (e.g. 406A) and reading results from another file (e.g. 406B).

To allow multiple communications, a technique can be employed to distinguish communications messages (e.g. incoming, outgoing, and subsequent messages) from one another. This can be accomplished by disabling OS read/write caching on the file 406A. Alternatively, this can be accomplished by opening a different file or using different areas 602-606 (defined, for example, by logical offsets 000001, N1, and N2) of the file 600 for different message classifications. For example, incoming messages can be devoted to all of file 406A and outgoing messages to all of file 406B. Or, incoming messages can be devoted to area 602, and outgoing messages to area 604 within file 600.

FIG. 6B is a diagram illustrating yet another embodiment, in which writing to and reading from the file 600 is accomplished via a window 608 that slides within the file 600. The token 200 interprets any write as a command and any read command as retrieving result, and can do so independent of what the file offset is. In this embodiment, the first operation is accomplished with the use of the emulated registers within the window 600 (e.g. registers 000001-000003). The window 608 is slid to position 608′ and the next operation is accomplished with the use the emulated registers 000004-000006, and the next, with the window in position 608″ and registers 000007-000009. When the end of the emulated file is reached, the window 608 can cycle back to include the first register 00001, or can slide upwards. In some circumstances, it is desirable that the emulated file 600 be a very large file to accommodate many operations.

### Human Interface Device Emulation

The USB Human Interface Device class is well suited for generic communication. This is because both input to and output from an HID device can be initiated by the application 110. This can be accomplished, for example, by appropriate application 110 commands to receive “reports” or to set/query “features”. Commands and responses that can be used to emulate an HID are described in “Universal Serial Bus (USB) Device Class Definition for Human Interface Devices (HID), Firmware Specification,” Version 1.1, by the USB Implementer's Form, Jun. 27, 2001, which is hereby incorporated by reference herein. This document is available at www.usb.org/developers/devclass_docs/HID1_{—}11.pdf.

Although the token 200 can emulate a variety of HIDs, it should not ordinarily emulate a keyboard 114 or mouse 116 as that would interfere with the normal use of the computer 102.

### Audio Device Emulation

Most OSs 108 include a USB audio device driver, which allows applications 110 to use popular or generic audio devices. The token 200 may enable two-way communications with the computer 102 by emulating two such devices (as interfaces) to communicate with the application 110. For example, in one embodiment, token 200, by emulation of a recording/playback device, may accept input from the host computer 102 by emulating a “speaker” device, and provide an output to the host computer by emulating a “microphone” device. That is, to communicate with the token 200, an application 110 can send a command to the token 200 as a digital “sound” to the “speaker” interface” and retrieve the output result by reading the digital “sound” from the “microphone” interface. Commands and responses that can be used to emulate an audio devices can be found in “Universal Serial Bus Device Class Definition for Audio Devices,” Release 1.0, by the USB Implementer's Form, Mar. 18, 1998, which is hereby incorporated by reference herein. This document is available at www.usb.org/developers/devclass_docs/audio10.pdf. Documents describing other USB-compliant device interface definitions are available at www.usb.org/developers/devclass_docs# approved.

### Conclusion

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of communicating information between a token and a host computer having a host computer operating system (OS) supplied inherent driver for communicating with an OS-supported USB-compliant device, the method comprising the steps of:
coupling to the host computer; and
emulating the OS-supported USB-compliant device.

2. The method of claim 1, wherein the step of emulating the OS-supported USB-compliant device comprises the steps of:
accepting a message from the OS-supplied inherent driver in the token, the message transmitted according to a format and protocol for the OS-supported USB-compliant device;
generating a second message from the accepted first message; and
providing a second message from the token to the OS-supplied inherent driver.

3. The method of claim 1, wherein the OS-supplied inherent driver is a hub driver, and the token emulates an empty hub.

4. The method of claim 3, wherein the host computer communicates with the token via hub commands and the token communicates with the host computer via a hub port status response or a read descriptor value.

5. The method of claim 4, wherein the hub commands are selected from a group comprising:
enable/disable commands; and
power on/power off commands.

6. The method of claim 1, wherein the OS-supplied inherent driver is a mass storage driver.

7. The method of claim 6, wherein the host computer communicates with the token via the mass storage driver writing to at least a portion of a file emulated in the token, and wherein the token communicates with the host computer via writing to at least a second portion of the file.

8. The method of claim 6, wherein the host computer communicates with the token via the mass storage driver writing to at least a portion of a file emulated in the token, and wherein the token communicates with the host computer via writing to the at least a portion of the file.

9. The method of claim 1, wherein the OS-supplied inherent driver is a human interface driver.

10. The method of claim 9, wherein the host computer communicates with the token via a setting/querying human interface driver feature, and the token communicates with the host computer via a report.

11. The method of claim 1, wherein the driver is an audio driver.

12. The method of claim 11, wherein the host computer communicates with the token via an audio output and the token communicates with the host computer via an audio input.

13. An apparatus for communicating information between a token and a host computer having a host computer operating system (OS) supplied inherent driver for communicating with an OS-supported USB-compliant device, comprising:
means for coupling to the host computer; and
means for emulating the OS-supported USB-compliant device.

14. The apparatus of claim 13, wherein the means for emulating the OS-supported USB-compliant device comprises:
means for accepting a message from the OS-supplied inherent driver in the token, the message transmitted according to a format and protocol for the OS-supported USB-compliant device;
means for generating a second message from the accepted first message; and
means for providing a second message from the token to the OS-supplied inherent driver.

15. The apparatus of claim 14, wherein the driver is a hub driver, and the token emulates an empty hub.

16. The apparatus of claim 15, wherein the host computer communicates with the token via hub commands and the token communicates with the host computer via a hub port status response or a read descriptor value.

17. The apparatus of claim 16, wherein the hub commands are selected from a group comprising:
enable/disable commands; and
power on/power off commands.

18. The apparatus of claim 13, wherein the OS-supplied inherent driver is a mass storage driver.

19. The apparatus of claim 18, wherein the host computer communicates with the token via the mass storage driver writing to at least a portion of a file emulated in the token, and wherein the token communicates with the host computer via writing to at least a second portion of the file.

20. The apparatus of claim 18, wherein the host computer communicates with the token via the mass storage driver writing to at least a portion of a file emulated in the token, and wherein the token communicates with the host computer via writing to the at least a portion of the file.

21. The apparatus of claim 13, wherein the OS-supplied inherent driver is a human interface driver.

22. The apparatus of claim 21, wherein the host computer communicates with the token via a setting/querying human interface driver feature, and the token communicates with the host computer via a report.

23. The apparatus of claim 13, wherein the driver is an audio driver.

24. The apparatus of claim 23, wherein the host computer communicates with the token via an audio output and the token communicates with the host computer via an audio input.

25. An apparatus for communicating information between a token and a host computer having a host computer operating system (OS) supplied inherent driver for communicating with an OS-supported USB-compliant device, comprising:
a USB port for coupling to the host computer, and
a processor, communicatively coupled to a memory storing instructions for emulating the OS-supported USB-compliant device.

26. The apparatus of claim 25, wherein the memory stores further instructions comprising:
instructions for accepting a message from the OS-supplied inherent driver in the token, the message transmitted according to a format and protocol for the OS-supported USB-compliant device;
instructions for generating a second message from the accepted first message; and
instructions for providing a second message from the token to the OS-supplied inherent driver.

27. The apparatus of claim 25, wherein the OS-supplied inherent driver is a hub driver, and the token emulates an empty hub.

28. The apparatus of claim 27, wherein the host computer communicates with the token via hub commands and the token communicates with the host computer via a hub port status response or a read descriptor value.

29. The apparatus of claim 28, wherein the hub commands are selected from a group comprising:
enable/disable commands; and
power on/power off commands.

30. The apparatus of claim 25, wherein the OS-supplied inherent driver is a mass storage driver.

31. The apparatus of claim 30, wherein the host computer communicates with the token via the mass storage driver writing to at least a portion of a file emulated in the token, and wherein the token communicates with the host computer via writing to at least a second portion of the file.

32. The apparatus of claim 30, wherein the host computer communicates with the token via the mass storage driver writing to at least a portion of a file emulated in the token, and wherein the token communicates with the host computer via writing to the at least a portion of the file.

33. The apparatus of claim 25, wherein the OS-supplied inherent driver is a human interface driver.

34. The apparatus of claim 33, wherein the host computer communicates with the token via a setting/querying human interface driver feature, and the token communicates with the host computer via a report.

35. The apparatus of claim 25, wherein the driver is an audio driver.

36. The apparatus of claim 36, wherein the host computer communicates with the token via an audio output and the token communicates with the host computer via an audio input.
